(19) United States
(12) Patent Application Publication
(10) Pub. No.: US 2008/0064263 A1
(43) Pub. Date: Mar. 13, 2008

(54) Cable connector

(75) Inventors: Ming Zhang, Kunshan (CN); Biao-Bing Lv, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND.CO., LTD.

(21) Appl. No.: 11/900,668

(22) Filed: Sep. 13, 2007

(30) Foreign Application Priority Data
Sep. 13, 2006 (CN) 200620076594.5

(51) Int. Cl. H01R 9/03

(52) U.S. Cl. 439/624

(57) ABSTRACT

A cable connector includes a first connector and a second connector. The first connector comprises a first housing defining a receiving space for receiving the second connector, and a plurality of contacts assembled to the first housing, each having a contacting arm exposed in the receiving space and an engaging arm disposed on a top surface of the first housing for being soldered with cables easily. The second connector comprises a second housing received in the receiving space of the first housing and a plurality of terminal received in the second housing for electrically contacting with the contacting arms of the contacts of the first connector.

### BACKGROUND OF THE INVENTION

1. Field of the Invention

The present invention relates to a cable connector for electrically connecting cables to a print circuit board.

2. Description of Related Art

Following development of electronic and communication technology, more and more different connectors are widely used for connecting electronic equipments, such as a cable connector, which is used for connecting cables to a print circuit board and builds signal transmission path between the cable and the print circuit board.

JP. Patent Application publication No. 2000-331731 discloses such a cable connector, which comprises a first connector connecting with a plurality of cables, and a second connector assembled to a print circuit board. The first connector has a first housing, a plurality of power contacts and signal contacts received in the first housing and each having a U-shaped contacting portion with an opening mouth, and a pressing plate having a haulm for pressing the cables to the U-shaped contacting portions. The cables are transversely disposed upon the mouths of the first and the second contacts, then the pressing plate press the cables downwardly toward bottoms of the mouths to make each of the cables form a U-shaped ends, whose opposed legs abut against and electrically contact with corresponding opposed inner sides of a corresponding mouth. The second connector has a second housing and a plurality of third contacts for electrically connecting with the first and the second contacts. The first connector engages with the second connector to electrically connect the cables to the print circuit board.

However, the pressing plate is an accessory component, which may cause increased cost and complex manufacture process. And when the pressing plate presses the cables downwardly, the sidewall of the first housing will also be indirectly pressed that may destroy the sidewall, on the otherwise, for the mouth of the contacts are used for receiving the cables, no plastic fills there, so the intensity of the first housing is not enough.

Hence, an improved cable connector is required to overcome the disadvantages of the prior art.

### SUMMARY OF THE INVENTION

An object of the present invention is to provide a cable connector in which the cables reliably electrically connects with contacts.

Accordingly, to achieve above-mentioned object, a cable connector of present invention includes a first connector comprising a first housing and a plurality of contacts assembled to the first housing, and a second connector comprising a second housing and a plurality of terminal received in the second housing. The first housing defines a receiving space recessed from a bottom surface thereof and a plurality of holes extending downwardly from a top surface thereof and communicating with the receiving space. Each contact has a contacting arm received in the holes and exposed in the receiving space and an engaging arm being disposed on a top surface of the first housing for being soldered with a cable easily. The second housing is accepted in the receiving space of the first housing, and the terminals of the second connector are electrically contacting with the contacting arms of the contacts of the first connector.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a perspective view of a cable connector of the present invention;

FIG. 2 is a partially exposed, perspective view of the cable connector of the present invention;

FIG. 3 is an assembled, perspective view of a first connector and a second connector the cable connector, taken from a bottom side;

FIG. 4 is an exploded, perspective view of the cable connector of the present invention;

FIG. 5 is a perspective view of the first connector of the cable connector;

FIG. 6 is a cross-sectional view of the first connector taken along line 6-6 of FIG. 5.

FIG. 7 is a cross-sectional view of the first connector taken along line 7-7 of FIG. 5.

FIG. 8 is a cross-sectional view of the cable connector taken along line 8-8 of FIG. 2.

### DETAILED DESCRIPTION OF THE INVENTION

Reference will now be made in detail to the preferred embodiment of the present invention.

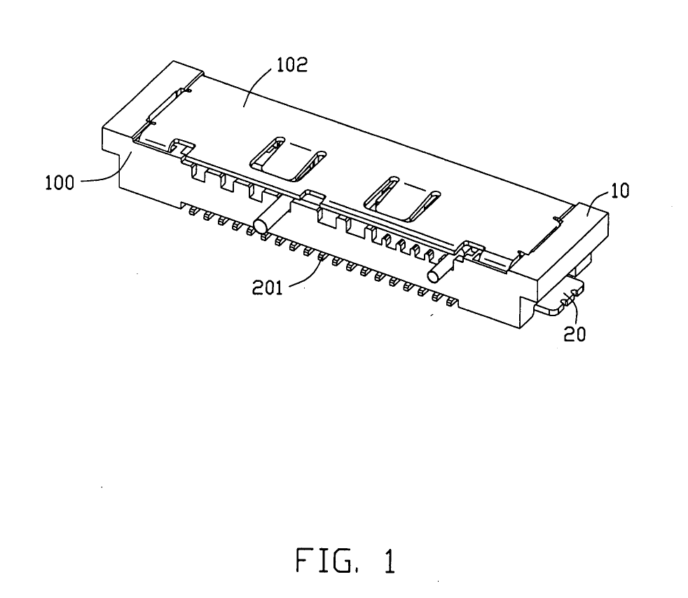

Referring to FIGS. 1-3, the cable connector in accordance with the present invention is used to connect cables (not labeled) to a print circuit board (not shown). The cable connector comprises a first connector 10 and a second connector 20. The first connector 10 has a first housing 100 defining a U-shaped receiving space 114 for the second connector 20, a plurality of power contacts 101a and signal contacts 101b and a shell 102 covering the first housing. The second connector 20 has a second housing 200 and a plurality of terminals 201 received in the housing 200 for electrically connecting with the power and the signal contacts 101a, 101b.

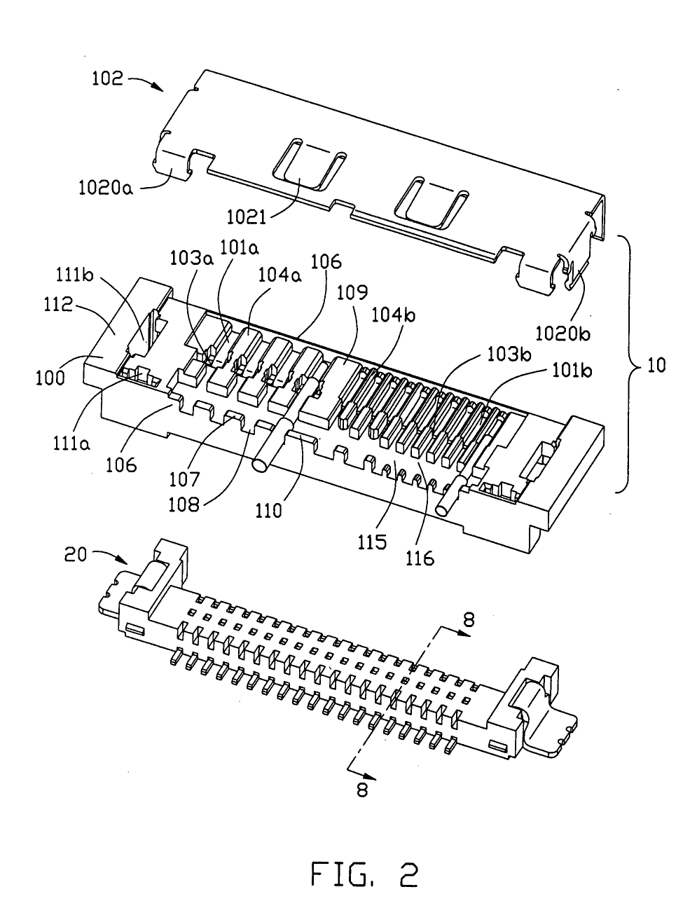

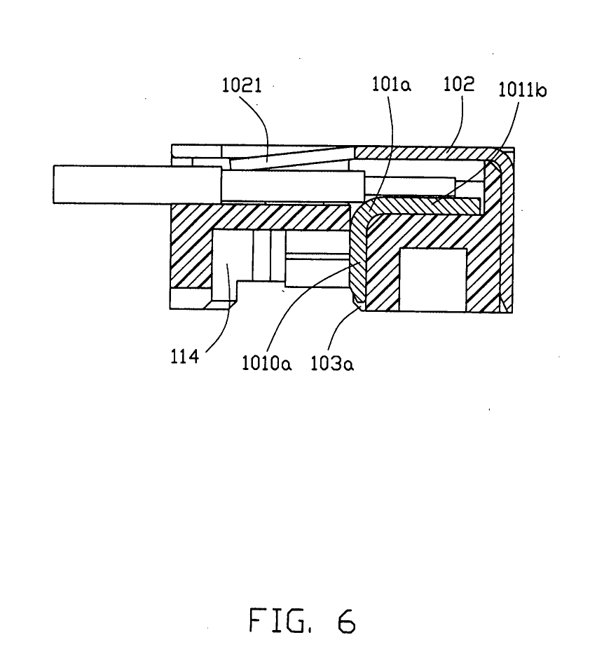

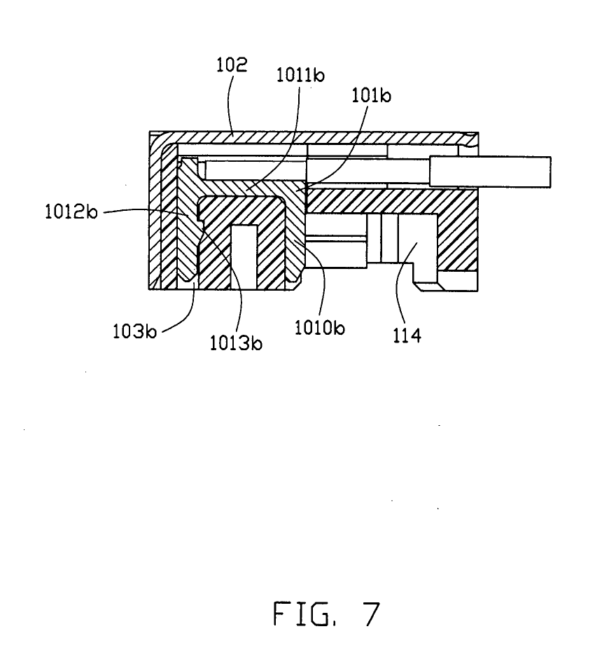

Referring to FIGS. 2-5, conjoint with FIG. 6-7, the first housing 100 is a longitudinal body and has two lateral ends 112, a front and a rear sidewall 106 and an approximately rectangular main body 115 surrounded by the ends 112 and sidewalls 106. A protruding bar 109 is disposed in a center part of the main body 115 and divided the main body 115 into two a right part and a left part.

The left part of the main body 115 is formed with a plurality of parallel ribs 104a on a top surface 116 thereof which are linked with the front sidewall 106, a plurality of slots 105a defined by two adjacent ribs 104a, and a plurality of first through hole 103a (referring to FIG. 6) extending downwardly from a part of each slots 104a and through the first housing 100 in a vertical direction for accommodating the power contacts 101a. The right part of the main body 115 is formed with a plurality of parallel ribs 104b on the top surface 116 which is narrower than the rids 104a and also linked with the front sidewall 106, a plurality of slots 105b defined by two adjacent ribs 104b, and a plurality of second through hole 103b (referring to FIG. 7), which are arranged in a front and a rear row and respectively downwardly extending from the slots 105b through the first housing 100 in a vertical direction for retaining the signal contacts 101b.

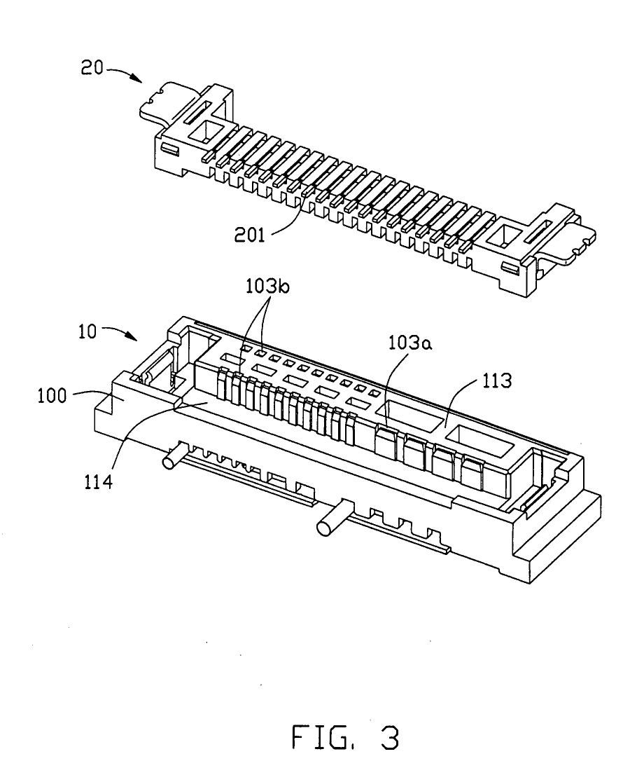

All of the protruding bar 109 and ribs 104a, 104b are extending along a front-to-back direction. The rear sidewall 106 is formed by a plurality of pieces 107 protruding from a rear edge of the top surface 116 of the main body 115, and two adjacent pieces 107 define a gaps 108 therebetween, respectively aligned with a corresponding slot 105a or slot 105b for setting the cables. Each end 112 is provides with two latching holes 111a, 111b respective in an outside and a rear side thereof. Referring to FIG. 3, which shows a bottom view of the first connector 10, the first housing 100 defines the U-shaped receiving space 114 recessed from a rear side of a bottom surface 113 thereof. Bottom parts of the first through holes 103a and the second through holes 103b in a rear line communicate with the receiving space 114 for exposing the power and signal contacts 101a, 101b in the receiving space 114.

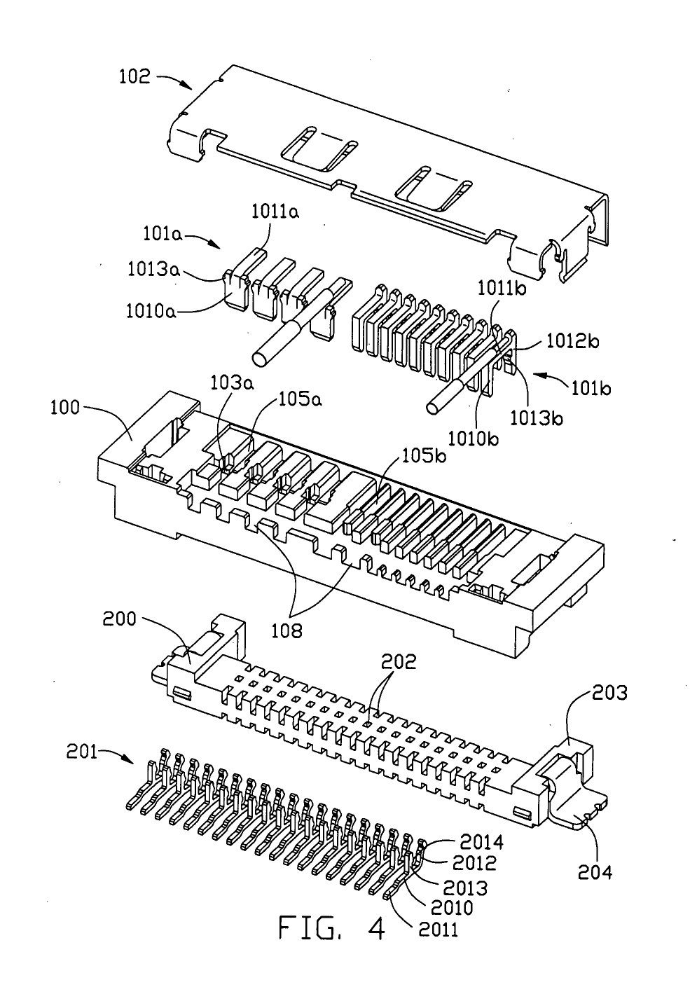

referring to FIG. 4, the power contact 101a is approximately in an L-shaped, each has a vertical contacting arm 1010a with stabs 1013a on two lateral sides used for retaining the power contact 101a to the first through hole 103a, and an engaging arm 1011a forwardly and horizontally extending from a top end of the contacting arm 1010a. When assembly, the power contacts 101a are downwardly assembled to the first housing 100, in a manner that the contacting arms 1010a insert into correspond first through holes 103a, and the engaging arms 1011a are disposed in the slots 105a.

The signal contact 101b is approximately in a U-shaped, each has a vertical contacting arm 1010b, a vertical retaining arm 1012b with stabs 1013b and a horizontal engaging arm 1011b linking top ends of the contacting arm 1010b and the retaining arm 1012b. When assembly, the second contacts 101b are downwardly assembled to the first housing 100, in a manner that the contacting arms 1010b and retaining arms 1012b respectively insert into the rear and the front second through holes 103b, and the engaging arms 1011b are disposed in the slots 105b. Furthermore, the front of each engaging arm 1010b has a projecting portion (not labeled), on which the cables depend.

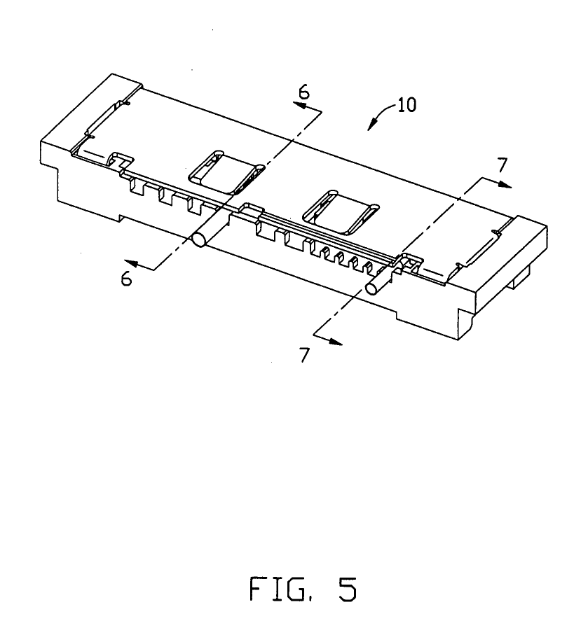

The shell 102 is stamped from a metal piece, and has a pair of latching arms 1020a, 1020b on opposed ends thereof. When assembly, the shell 102 covers the top surface 116 and a front surface of the first housing 100, the latching arms 1020a, 1020b insert into and engage with the corresponding latching holes 111a, 112b to retain the shell 102 to the first housing 100. Furthermore, two pressing piece 1021 are formed on a top of the shell 102 for pressing the cables. Referring to FIG. 5, it should be noted that the shell 102 assembles to the first housing 100, after the cables electrically connect to the power and the signal contacts 101a, 101b, which are already mounted on the first housing 100.

Here, we will describe the process of the cable assembling to the first housing, the cables have a plurality of power cables to be seated in the left part of the main body 115, and a plurality of signal cables to be seated in the right part of the main body 115. Since each of the slots 105a, 105b is aligned with a gaps 108 defined on the front sidewall 106, the power cables are respectively disposed in the slots 105a and corresponding gaps 108, the signal cables are respectively disposed in the slots 105b and corresponding gaps 108. Cable cores in a front end of the cables are respectively located upon the engaging arms 1011a, 1011b of the power and the signal contacts 101a, 101b, then solder the cable cores to the engaging arms 1011a, 1011b to establish an electrical transmission path between the cables and the first connector 10.

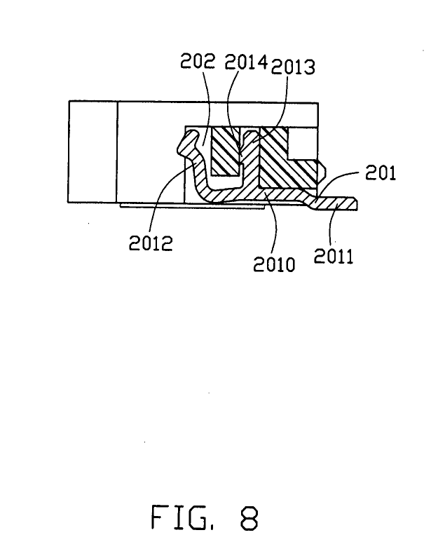

Referring to FIGS. 3, 4 and 8, The second connector 20 comprises a U-shaped second housing 200 having an elongated body with a plurality of groove 202, two ends 203 extending forwardly beyond the main body and each assembling a soldering pad 204 on an outside surface thereof, and a plurality of terminals 201 received in the groove 202. The terminals 201 comprises a contact portion 2012 exposed out of a front surface of the second housing 200, a vertical retaining portion 2013 with stabs 2014 and a horizontal portion 2010 linking the contact portion 2012 and the retaining portion 2013 and extending rearward beyond the second housing 200 with a tail 2011 for being soldered to a print circuit board (not shown). Conjoint with FIG. 1, the second housing 200 of the second connector 20 is completely received in the receiving space 114 of the first connector 10, the soldering pads 204 laterally extend out. The contact portions 2012 of the terminals 201 respectively abut against and electrically contact with the contacting arms 1010a, 1010b of the power and the signal contacts 101a, 101b exposed in the receiving space 114 (referring to FIG. 6-8).

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A cable connector comprising:
a housing defining a receiving space recessed from a bottom surface thereof and a plurality of holes extending downwardly from a top surface thereof and communicating with the receiving space;
a plurality of contacts assembled to the housing, each contact having a contacting arm received in the hole and exposed in the receiving space and an engaging arm disposed on a top surface of the first housing.

2. The cable connector as described in claim 1, wherein the housing is formed with a plurality of parallel ribs on the top surface thereof and a plurality of slots respectively defined by every two adjacent ribs, the engaging arms of the contacts are located in the slots.

3. The cable connector as described in claim 2, wherein the holes of the housing extend downwardly from each slots, the contacting arm of each contact extends downwardly from the engaging portion into the holes to be exposed in the receiving space.

4. The cable connector as described in claim 3, wherein the housing is formed with a plurality of gaps in a rear side thereof, the gaps are respectively aligned with corresponding slots to regularly arrange the cables together with the slots.

5. The cable connector as described in claim 3, further comprises a shell assembled to and covering the housing, the housing defines at least one latching hole on two lateral ends thereof, and the shell is formed with at least one latching arm engaging with the latching hole of the housing and a least one pressing piece on a top thereof for pressing the cables.

6. The cable connector as described in claim 1, wherein the contacts include a plurality of power contacts and a plurality of signal contacts.

7. The cable connector as described in claim 6, wherein the power contact is in an L-shaped, the engaging arm extends forwardly and horizontally from a top of the contact arm, which is upright.

8. The cable connector as described in claim 6, wherein the signal contact is in a U-shaped and further comprises a retaining arm parallel to the contacting arm to retain the signal contact to the housing, the engaging arm extends horizontally and links tops of the contact arm and the retaining arm.

9. A cable connector comprising:
a first connector comprising a first housing and a plurality of contacts assembled to the first housing, the first housing defining a receiving space recessed from a bottom surface thereof and a plurality of holes extending downwardly from a top surface thereof and communicating with the receiving space, each contact having a contacting arm received in the holes and exposed in the receiving space and an engaging arm disposed on a top surface of the first housing;
a second connector comprising a second housing received in the receiving space of the first housing and a plurality of terminals received in the second housing for electrically contacting with the contacting arms of the contacts of the first connector.

10. The cable connector as described in claim 9, wherein the first housing is formed with a plurality of parallel ribs on the top surface thereof and a plurality of slots respectively defined by two adjacent ribs, the engaging arms are located in the slots.

11. The cable connector as described in claim 10, wherein the holes of the first housing extend downwardly from each slots, and the contacting arm extends downwardly from corresponding engaging portion to insert into the hole and be exposed in the receiving space.

12. The cable connector as described in claim 11, wherein the first housing is formed with a plurality of gaps in a rear side thereof, the gaps are aligned with the slots to regularly arrange the cables together with the slots.

13. The cable connector as described in claim 12, further comprising a shell assembled to and covering the first housing.

14. The cable connector as described in claim 11, wherein the second housing is in a U-shaped, and the receiving space of the first housing is a U-shaped space.

15. The cable connector as described in claim 10, wherein the contacts include a plurality of power contacts and a plurality of signal contacts.

16. The cable connector as described in claim 15, wherein the power contact is in an L-shaped, the engaging arm extends forwardly and horizontally from a top of the contact arm, which is upright.

17. The cable connector as described in claim 16, wherein the signal contact is in a U-shaped and further comprises a retaining arm parallel to the contacting arm to retain the signal contact to the housing, the engaging arm extends horizontally and links tops of the contact arm and the retaining arm.

18. A connector assembly comprising:
a board mount connector including:
an insulative first housing extending along a lengthwise direction and defining a first mating portion on one longitudinal side in a first face;
a plurality of first contacts disposed in the first housing with first contacting sections exposed to the first mating portion and with first soldering sections exposed to a first mounting area which is located on the other longitudinal side in a second face opposite to said first face; and
a plurality of wires extending into the first housing from said longitudinal side to the other longitudinal side with inner conductors soldered to the corresponding first soldering sections.

19. The connector assembly as claimed in claim 18, further including a second connector comprising an insulative second housing extending along said lengthwise direction and defining a second mating portion on one longitudinal side which is coupled to the first mating portion under a condition that said second connector is equipped with a plurality of second contacts with second contacting sections located around the second mating portion and mated with the corresponding first contacting sections of the first contacts.

20. The connector assembly as claimed in claim 19, wherein said second connector is equipped with a pair of fastening pads at two opposite lengthwise ends under a condition that both said fastening pads are essentially aligned with a lengthwise center line of the housing instead of being offset on one side.
